(19) United States
(12) Patent Application Publication
(10) Pub. No.: US 2009/0162624 A1
(43) Pub. Date: Jun. 25, 2009

(54) SUBSTRATES COATED WITH MALEIC ACID FOR ELECTROPHOTOGRAPHIC PRINTING METHOD

(75) Inventors: Hildegard Stein, Mannheim (DE); Roland Ettl, Ketsch (DE); Hubertus Peter Bell, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF SE, Ludwigshafen (DE)

(21) Appl. No.: 12/300,584

(22) PCT Filed: May 16, 2007
(86) PCT No.: PCT/EP07/54786

§ 371 Date: Nov. 12, 2008

(30) Foreign Application Priority Data
May 24, 2006 (EP) 06114477.0

(51) Int. Cl. B32B 5/00; G03G 13/10

(52) U.S. Cl. 428/211.1; 430/117.1; 428/195.1

(57) ABSTRACT

A process for printing on substrates, wherein the substrates are pretreated with a composition which comprises a polymer obtainable by free radical polymerization of ethylenically unsaturated compounds (monomers) (referred to below as polymer for short), and at least 1% by weight of the monomers are monomers having two carboxyl groups (dicarboxylic acid) or a dicarboxylic anhydride group (summarized below as anhydride monomer for short).

The invention relates to processes for printing on substrates, wherein the substrates are pretreated with a composition which comprises a polymer obtainable by free radical polymerization of ethylenically unsaturated compounds (monomers) (referred to below as polymer for short), and at least 1% by weight of the monomers are monomers having two carboxyl groups (dicarboxylic acid) or a dicarboxylic anhydride group (summarized below as anhydride monomer for short).

An essential feature of electrophotographic printing processes is that electrostatically charged dye systems, so-called toners, are used and an electrostatic charge image is produced and can be developed in various ways.

In the electrophotographic printing processes, two physically different toner systems are used: dry toner (i.e. toner which is present in solid form at room temperature and becomes liquid only under the action of heat at relatively high temperatures of about 130° C.) and liquid toner (toner which has a very low melting point). Electrostatic printing processes using a liquid toner are also referred to as LEP (liquid electrostatic printing) or indigo printing processes.

Owing to the low melting point and the low fixing temperature of the toner on the paper (in general from 40 to 100° C.), the toner adhesion to paper is frequently insufficient in the LEP process.

WO 96/06384 describes the improvement of the adhesion of the liquid toner to paper substrates by treatment of the surface with substances which carry a basic functionality, exclusively and preferably polyethylenimines (PEI, e.g. Polymin P), ethoxylated PEIs, epichlorohydrins/polyethylenimines and polyamides being mentioned. A decisive disadvantage of this method of treatment, however, is the loss of whiteness and the yellowing of the paper on prolonged storage.

U.S. Pat. No. 5,281,507 describes the use of (partly) fluorinated hydrocarbons or surfactants on the substrate surface for improving the printed image and the toner adhesion.

In EP-A 0 879 917, mixtures of salts (e.g. aluminate salts or salts of a weak acid and a strong base) are used in order to impart to the paper surface an alkaline pH, which in turn results in improved printability by means of a liquid toner.

WO 2004/092483 describes the surface treatment of paper with a combination of starch, an acrylic acid polymer and a further organic compound, e.g. a polyglyceryl ester. The use of the polyglyceryl ester is regarded as essential for achieving good toner fixing.

An object of the present invention was the improvement of the electrostatic printing processes, in particular of the LEP process. Another object was to provide suitable substrates for such printing processes. By measures which are as simple as possible, it was intended in particular to permit as good fixing as possible of the liquid toner on different paper grades.

Accordingly, the process defined above was found.

A substantial feature of the invention is that the substrates are pretreated with a composition which comprises a polymer obtainable by free radical polymerization of ethylenically unsaturated compounds (monomers) (referred to below as polymer for short), and at least 1% by weight of the monomers are monomers having two carboxyl groups (dicarboxylic acid) or having a dicarboxylic anhydride group (summarized below as anhydride monomers for short).

### Composition

### Regarding the Polymer

The polymer is obtainable by free radical polymerization of ethylenically unsaturated compounds (monomers). Where it is stated below that the polymer consists of this monomer or comprises monomers, it should be noted that the monomers are of course no longer present as ethylenically unsaturated compounds after the polymerization.

The polymer comprises anhydride monomers. In particular, dicarboxylic acids or dicarboxylic anhydrides having 4 to 8 carbon atoms, for example maleic anhydride or maleic acid (mentioned together as MAA for short), itaconic anhydride, citraconic anhydride and methylenemalonic anhydride may be mentioned as anhydride monomers. MAA or itaconic anhydride is preferred, particularly preferably MAA.

The polymer preferably comprises at least 2, in particular at least 5, % by weight, particularly preferably at least 10% by weight or at least 20% by weight of anhydride monomers.

The content of anhydride monomers in the polymer may be, for example, from 2 to 80% by weight, in particular from 20 to 80% by weight.

The anhydride monomers may also be present in the form of their salts.

In addition to the anhydride monomers, the polymer may comprise monomers (b), selected from C1-C20-alkyl (meth)acrylates, vinyl esters of carboxylic acids comprising up to 20 carbon atoms, vinylaromatics having up to 20 carbon atoms, ethylenically unsaturated nitriles, vinyl halides, vinyl ethers of alcohols comprising 1 to 10 carbon atoms, aliphatic hydrocarbons having at least 2 carbon atoms and one or two double bonds or mixtures of these monomers.

Alkyl (meth)acrylates having a C1-C10-alkyl radical, such as methyl methacrylate, methyl acrylate, n-butyl acrylate, ethyl acrylate and 2-ethylhexyl acrylate, may be mentioned by way of example.

In particular, mixtures of the alkyl (meth)acrylates are also suitable.

Vinyl esters of carboxylic acids having 1 to 20 carbon atoms are, for example, vinyl laurate, vinyl stearate, vinyl propionate, vinyl versatate and vinyl acetate.

Suitable vinylaromatic compounds are vinyltoluene, α- and p-methylstyrene, α-butylstyrene, 4-n-butylstyrene, 4-n-decylstyrene and preferably styrene. Examples of nitriles are acrylonitrile and methacrylonitrile.

The vinyl halides are ethylenically unsaturated compounds substituted by chlorine, fluorine or bromine, preferably vinyl chloride and vinylidene chloride.

For example, vinyl methyl ether or vinyl isobutyl ether may be mentioned as vinyl ethers. Vinyl ethers of alcohols comprising 1 to 4 carbon atoms are preferred.

Monoolefins, such as ethylene, propylene or isobutylene, in particular oligomers thereof, such as polyisobutene (PIB), or diolefins, such as butadiene, isoprene and chloroprene, may be mentioned as hydrocarbons having at least 2 carbon atoms and one or two olefinic double bonds. The monoolefins are preferred.

Preferred monomers (b) are monoolefins, in particular ethylene, isobutylene, polyisobutylene, C1- to C10-alkyl acrylates and methacrylates, in particular C1- to C8-alkyl acrylates and methacrylates, and vinylaromatics, in particular styrene, and mixtures of these monomers.

Ethylene and isobutylene or polyisobutylene are particularly preferred as monomers (b).

MAA copolymerizes with olefins only in an alternating manner. MAA/olefin copolymers therefore generally have a content of not more than 55 mol % of MAA. The molar fraction of MAA in the MA/olefin copolymer is in particular from 5 to 55 mol %, particularly preferably from 20 to 55 mol % and very particularly preferably from 45 to 55 mol %.

In addition to the monomers (b), the polymer or polymer mixture may comprise any desired further auxiliary monomers (c), for example monomers having a carboxyl group or having sulfo or phosphonic acid groups.

Other auxiliary monomers are, for example, monomers comprising hydroxyl groups, in particular C1-C10-hydroxyalkyl (meth)acrylates, and (meth)acrylamide.

For example, monoethylenically unsaturated C3- to C10-monocarboxylic acids, such as acrylic acid, methacrylic acid, ethylacrylic acid, allylacetic acid, crotonic acid or vinylacetic acid, maleic acid monoesters such as monomethyl maleate, mixtures thereof and alkali metal and ammonium salts thereof are suitable.

In addition, phenyloxyethyl glycol mono(meth)acrylate, glycidyl acrylate, glycidyl methacrylate and amino (meth)acrylates, such as 2-aminoethyl (meth)acrylate, may be mentioned as auxiliary monomers (c).

Crosslinking monomers may also be mentioned as auxiliary monomers.

N-vinylformamide, N-vinyl-N-methylformamide, N-vinylpyrrolidone, N-vinylimidazole, 1-vinyl-2-methylimidazole, 1-vinyl-2-methylimidazolone, N-vinylcaprolactam, allyl alcohol, 2-vinylpyridine, 4-vinylpyridine, acrolein, methacrolein and mixtures thereof may also be mentioned.

In total, the polymer is preferably composed of

from 2 to 80% by weight of anhydride monomer (a)

from 20 to 98% by weight of monomers (b)

from 0 to 30% by weight of auxiliary monomers (c).

In total, the polymer is particularly preferably composed of

from 10 to 80% by weight of anhydride monomer

from 30.0 to 90% by weight of monomers (b) and

from 0 to 30% by weight of auxiliary monomers (c).

The polymers can be prepared by conventional polymerization processes, for example by mass, emulsion, suspension, dispersion, precipitation and solution polymerization. Said polymerization processes are preferably carried out in the absence of oxygen, preferably in a nitrogen stream. For all polymerization methods, the conventional apparatuses are used, e.g. stirred kettles, stirred kettle cascades, autoclaves, tubular reactors and kneaders. The solution, emulsion, precipitation or suspension polymerization method is preferably employed. Particularly preferred are the methods of solvents or diluents, such as, for example, toluene, o-xylene, p-xylene, cumene, chlorobenzene, ethylbenzene, industrial mixtures of alkylaromatics, cyclohexane, industrial aliphatics mixtures, acetone, cyclohexanone, tetrahydrofuran, dioxane, glycols and glycol derivatives, polyalkylene glycols and derivatives thereof, diethyl ether, tert-butyl methyl ether, methyl acetate, isopropanol, ethanol, water or mixtures, such as, for example, isopropanol/water mixtures, carried out. A preferably used solvent or diluent is water, if appropriate with proportions of up to 60% by weight of alcohols or glycols. Water is particularly preferably used.

The polymer is preferably an emulsion polymer or solution polymer.

The polymer is preferably present in the form of an aqueous dispersion or aqueous solution; the solids content is preferably from 10 to 80% by weight, particularly from 30 to 65% by weight.

### Regarding Further Constituents

In a further preferred embodiment, the composition also comprises starch in addition to the polymer.

In this context, starch is to be understood as meaning any natural, modified or degraded starch. Natural starches may consist of amylose, amylopectin or mixtures thereof. Modified starch may be oxidized starch, starch ester or starch ether. Anionically, cationically, amphoterically or nonionically modified starch is suitable.

The molecular weight of the starch can be reduced by hydrolysis (degraded starches). Suitable degradation products are oligosaccharides or dextrins.

The starch may originate from various sources; for example, it may be cereal-corn or potato starch, in particular, for example, starch obtained from corn, waxy corn, rice, tapioca, wheat, barley or oats.

Potato starch or modified or degraded potato starch is preferred.

In particular, the composition comprises from 10 to 100 parts by weight, particularly preferably from 50 to 100% by weight, of polymer and from 90 to 0 parts by weight, particularly preferably from 50 to 0% by weight, of starch, based on 100 parts by weight of the sum of polymer and starch.

The composition may comprise further constituents; suitable additives are described, for example, in WO 2004/092483; for example, polyglyceryl esters may be mentioned.

However, the concomitant use of further additives is not absolutely essential in the present invention; in particular, no further additives are required for improved adhesion of the toner.

It is preferably an aqueous composition, in particular a composition in which the polymer and, if appropriate, the starch are present in dissolved or dispersed form.

The composition can be applied by conventional methods to the substrates to be printed on; methods in which the composition does not diffuse or scarcely diffuses into the substrate are preferred, for example application with a film press, by spraying or by curtain coating.

### Regarding the Process and the Substrates to be Printed On

The substrates pretreated with the composition are preferably printed on in an electrophotographic printing process.

A substantial feature of electrophotographic printing processes is that electrostatically charged dye systems, so-called toners, are used and an electrostatic charge image is produced and can be developed in various ways.

Said printing process is particularly preferably the electrostatic printing process referred to as LEP (liquid electrostatic printing) or indigo printing process.

A substantial feature of this printing process is the use of a liquid toner which is present as a liquid or as a viscous paste at room temperature (20° C.).

The temperature at which the toner is fixed on the substrate is relatively low in comparison with other electrostatic processes and is, for example, from 40 to 100° C.

The substrate to be printed on may be, for example, paper or polymer film.

It is preferably uncoated paper, i.e. base paper, which is not coated with a paper coating slip, but other paper grades may also be treated therewith in order to improve the adhesion of the liquid toner.

In particular, the substrate to be printed on may also be wood-free paper.

The substrate to be printed on is pretreated, in particular coated (see above), with the composition. The amount of the composition is preferably from 0.05 g/m² to 15 g/m² (solid), preferably from 0.1 g/m² to 5 g/m² (solid).

By using the pretreated substrates, outstanding results are obtained in conventional printing processes, but in particular in electrostatic processes and preferably in the LEP process. The adhesion of the toner to the substrate is very good and the printed image has a high quality.

### EXAMPLES

### Example 1

245 g of maleic anhydride and 250 g of oligoisobutene (M_{w}=1000 g/mol) in 400 g of o-xylene were initially taken in a 2 l kettle having a dry ice condenser and heated to 120° C. in a gentle stream of nitrogen. After this temperature had been reached, 1050 g of oligoisobutene (M_{w}=1000 g/mol) were metered in in the course of 3 hours, 98 g of isobutene in the course of 5 hours and 10.4 g of tert-butyl peroctanoate, dissolved in 40 g of o-xylene, in the course of 5.5 hours. Heating was then continued for 1 hour at 120° C. After cooling to 90° C., 2900 g of water were added and the o-xylene was removed by steam distillation. The resulting reaction mixture was cooled to 60° C., 200 g of 50% strength sodium hydroxide solution were added and the water content was adjusted to 65% with water. Thereafter, stirring was effected for 1 hour at 60° C., followed by cooling to room temperature. Dispersion D.1 according to the invention was obtained. It had a pH of 6.7, M_{w}=about 10 000 g/mol.

### Example 2

108 g of maleic anhydride were dissolved in 490 g of Pluriol A 500 E (polyethylene glycol monomethyl ether, M_{w}=500 g/mol) and heated to 90° C. with stirring in a nitrogen atmosphere. At this temperature, 7.85 g of tert-butyl peroctanoate, dissolved in 67.2 g of Pluriol A 500 E, and a solution of 0.49 g of hydroquinone monomethyl ether in 112 g of styrene were slowly added dropwise in the course of two hours. The reaction mixture obtained was then stirred for one hour at 90° C. and then for 4 hours at 150° C., a brown oil forming. It was cooled to 85° C. The oil was diluted with 400 g of water, and 13.0 g of an aqueous hydrogen peroxide solution (30% by weight) were added. After stirring for a further 30 min, dilution was again effected with 170 g of water. At an internal temperature of not more than 40° C., the pH was adjusted to 8.5-9.5 with sodium hydroxide solution (50% by weight) and stirring was continued for two hours. The mixture was then cooled to room temperature. Dispersion D.2 according to the invention was obtained.

Characterization: pH: 8.7; K value (2% strength in water): 38.3*; GPC: number average Mₙ=3500; GPC weight average M_{w}=41 200; solids content: 54%.

The K values of copolymers according to the invention were determined according to H. Fikentscher, Cellulose-Chemie, volume 13, 58-64 and 761-774 (1932) in aqueous solution at 25° C. and a polymer concentration of 2% by weight.

### Application of the Starch/Polymer Mixtures

An oxidatively degraded potato starch was heated to 95° C. for 30 minutes according to the manufacturer's instructions at a concentration of 20% in water. Thereafter, the starch solution was diluted to 10% solids content and cooled to about 60° C. Formulations were prepared from this starch solution and the polymers described in the examples, the solids content of the prepared formulation being adjusted to 10%. These mixtures were applied by means of a size press to a wood-free paper (basis weight 90 g/m²). Thereafter, the papers were dried by contact drying at 90° C. and then conditioned for 24 hours at a relative humidity of 50% and a temperature of 24° C. The papers were then calendered (1 nip, 100 daN/cm).

The printing experiments were carried out on a Hewlett-Packard Indigo Digital printing press 3000. The toner adhesion was determined according to the tape pull method (DIN V EN V 12283) using a 3M#230 adhesive tape. For this purpose, the adhesive tape was stuck on the printed surface without bubbles and then peeled off at constant speed at an angle of almost 180°. After the pick test, the ink density of the print was determined by means of a densitometer and stated as a value in the table of results. The determination of the toner adhesion or of the ink density after the pick test was effected after certain time intervals (immediately/1 min/10 min/1 h/24 h).

| | Polymer | Parts by | Parts by | | | | | |
|---|---|---|---|---|---|---|---|---|
| Use | from | weight of | weight of | Ink density | | | | |
| example | example | polymer | starch | immediately | 1 min | 10 min | 1 h | 24 h |
| 5 | — | 0 | 100 | 25 | 32 | 46 | 82 | 91 |
| 6 | 1 | 55 | 45 | 45 | 64 | 80 | 89 | 100 |
| 7 | 2 | 55 | 45 | 51 | 68 | 81 | 92 | 100 |
| 8 | 1 | 100 | 0 | 54 | 73 | 89 | 94 | 100 |
| 9 | 2 | 100 | 0 | 63 | 78 | 92 | 99 | 100 |

1. A process for printing on substrates, which comprises:
pretreating the substrates with a composition which comprises a polymer obtainable by free radical polymerization of ethylenically unsaturated monomers, and at least 1% by weight of the monomers are ethylenically unsaturated dicarboxylic acid monomers or dicarboxylic acid anhydride group containing monomers.

2. The process according to claim 1, wherein the anhydride monomer is maleic acid or maleic anhydride.

3. The process according to claim 1, wherein the anhydride monomer comprises from 2 to 80% by weight of the polymer.

4. The process according to claim 1, wherein the anhydride monomer comprises from 20 to 80% by weight of the polymer.

5. The process according to claim 1, wherein the polymer is comprised of monomers (b) which are selected from the group consisting of C₁-C₂₀-alkyl (meth)acrylates, vinyl esters of carboxylic acids having up to 20 carbon atoms, vinylaromatics having up to 20 carbon atoms, ethylenically unsaturated nitrites, vinyl halides, vinyl ethers of alcohols having 1 to 10 carbon atoms, aliphatic hydrocarbons having at least 2 carbon atoms and one or two double bonds or mixtures of these monomers.

6. The process according to claim 1, wherein the polymer is composed of
from 2 to 80% by weight of anhydride monomer (a)
from 40 to 98% by weight of monomers (b) and
from 0 to 30% by weight of additional monomers (c).

7. The process according to claim 1, wherein the polymer is an ethylene/MAA copolymer which is comprised of 5 to 55 mol % MAA.

8. The process according to claim 1, wherein the polymer is present in the form of an aqueous dispersion or solution.

9. The process according to claim 1, wherein the composition is comprised of starch in addition to the polymer.

10. The process according to claim 1, wherein the composition is comprised of 10 to 100 parts by weight of polymer and from 0 to 90 parts by weight of starch, based on 100 parts by weight of the sum of polymer and starch.

11. The process according to claim 1, wherein the composition is an aqueous solution or dispersion.

12. The process according to claim 1, wherein the printing process is an electrophotographic process.

13. The process according to claim 1, wherein the printing process is the liquid electrophotographic printing process.

14. The process according to claim 1, wherein the substrate to be printed on is paper or a polymer film.

15. The process according to claim 1, wherein the substrate to be printed on is uncoated paper.

16. The process according to claim 1, wherein the substrate to be printed on is wood-free paper.

17. The process according to claim 1, wherein the substrate is coated or impregnated with the pretreating composition.

18. The process according to claim 1, wherein the substrate is coated or impregnated with from 0.05 g/m² to 15 g/m², of the composition.

19. A printed substrate obtainable by the process according to claim 1.

20. A paper which is coated or impregnated with a composition according to claim 1.
